(19) United States
(12) Patent Application Publication
(10) Pub. No.: US 2008/0032276 A1
(43) Pub. Date: Feb. 7, 2008

(54) Interactive system

(76) Inventor: Yu Zheng, Walnut, CA (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/598,958

(22) Filed: Nov. 14, 2006

Related U.S. Application Data
(63) Continuation-in-part of application No. 11/491,358, filed on Jul. 21, 2006.

(51) Int. Cl. G09B 5/00

(52) U.S. Cl. 434/317

(57) ABSTRACT

A interactive system and a method illustrates the subject matter of an object. The system has an object having an external surface, a housing, a selector that selects a specific location on the external surface, and a video screen that displays video images associated with the specific location. Electronics in the housing respond to the specific location selected by the selector, and transmits to the video screen signals representative of the video images.

### 1. RELATED CASES

This is a continuation of Ser. No. 11/491,358, filed Jul. 21, 2006, entitled “Interactive System”, whose entire disclosure is incorporated by this reference as though set forth fully herein.

### BACKGROUND OF THE INVENTION

1. Field of the Invention

The present invention relates to an interactive system, and to an interactive system that provides simultaneous audio and visual outputs to emulate a “live” experience.

2. Description of the Prior Art

There are a variety of interactive electronic book devices in which a book is placed on a platform. The platform includes a detection system where a generated response depends upon the portion of the book that is pointed to by a user-controlled stylus or pointing device. Such interactive books are configured to provide an audio output related to a stylus position. For example, an interactive book device for children may speak the words which are pointed to, or play games (or tell stories) when the child points at a picture. Examples of interactive book devices are illustrated in U.S. Pat. Nos. 5,575,659, 6,668,156 and 7,035,583, and in Pub. No. US2004/0043365.

There are also a variety of interactive globe toys where a spherical globe is supported on a stand or a platform. The surface of the globe includes a detection system where a generated response depends upon the portion of the globe that is pointed to by a user-controlled stylus or pointing device. Such interactive globes are configured to provide an audio output related to a stylus position. For example, an interactive globe may speak the names of geographic locations which are pointed to, or output verbal information about the geographic locations which are pointed to. Examples of interactive globes are illustrated in U.S. Pat. Nos. 6,661,405 and 5,877,458.

Most of the known interactive book devices and globes provide only audio output in response to a word or picture or region or location which is pointed at. Thus, the child or user only receives primarily an audio response, which is not always effective in creating or simulating a more “real” or “live” environment.

### SUMMARY OF THE INVENTION

It is an object of the present invention to provide an interactive object that provides the user with a “live” experience.

In order to accomplish the above-described and other objects of the present invention, the present invention provides a system and a method of illustrating the subject matter of the external surface of an object. The present invention provides an interactive system having an object having an external surface, a housing, a selector that selects a specific location on the external surface, and a video screen that displays video images associated with the specific location. Electronics in the housing respond to the specific location selected by the selector, and transmits to the video screen signals representative of the video images.

### BRIEF DESCRIPTION OF THE DRAWINGS

FIG. 1 is an exploded perspective view of a system according to one embodiment of the present invention.

FIG. 2 is a schematic block diagram of the electronics of the system of FIG. 1.

FIG. 3 is an exploded perspective view of a system according to another embodiment of the present invention.

FIG. 4 is an exploded perspective view of a system according to yet another embodiment of the present invention.

FIG. 5 is an exploded perspective view of the system of FIG. 4 showing the selection of a different point on the surface of the globe.

FIG. 6 is a schematic block diagram of the electronics of the systems of FIGS. 4, 7, 8 and 9.

FIG. 7 is a perspective view of the system of FIG. 4 shown with a hand-held unit.

FIG. 8 is a perspective view of the system of FIG. 7 shown with the hand-held unit coupled to the globe.

FIG. 9 is an exploded perspective view of a system according to yet another embodiment of the present invention.

FIG. 10 is an exploded perspective view of a system according to yet a further embodiment of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention provides an interactive system and a method for simulating a “live” experience for the user. In one embodiment, the system can be embodied in the form of an interactive book device that simulates a “live” experience associated with the subject matter of the book, or of a plurality of documents. In another embodiment, the system can be embodied in the form of an interactive three-dimensional object, such as a globe that simulates a “live” experience associated with the subject matter represented on the globe.

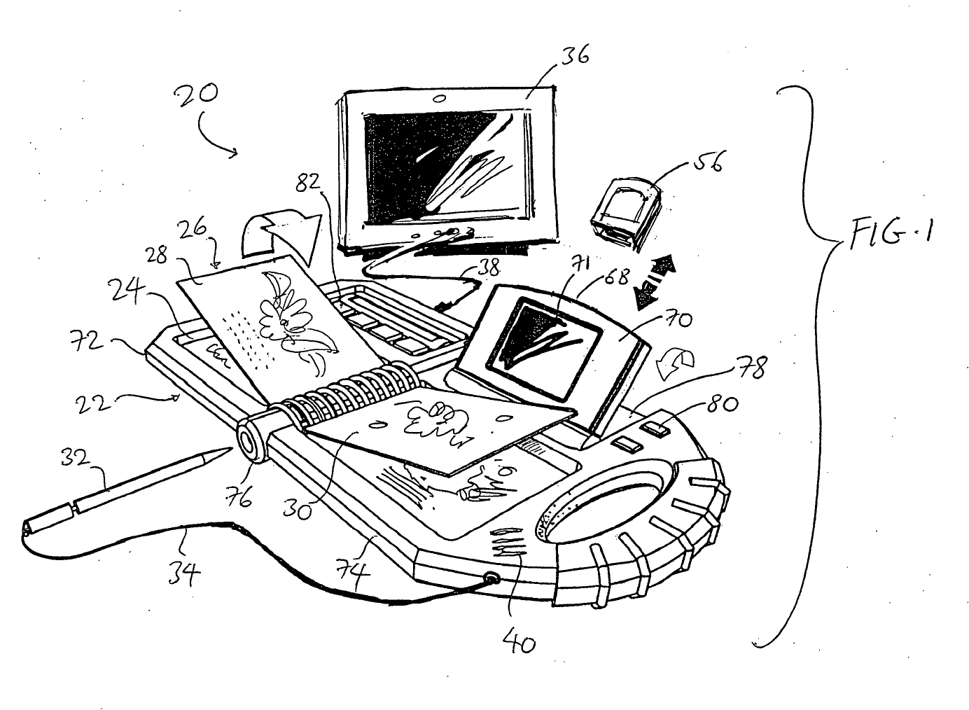

FIG. 1 illustrates an interactive system 20 according to one embodiment of the present invention. The system 20 includes a housing assembly that can be embodied in the form of a platform 22 having a receiving zone 24 that receives an open book 26, the topmost pages 28 and 30 of which are readable by a user. A selector, which can be a finger or any object, such as a stylus 32, is coupled to the platform 22 via a wire 34, and a screen or visual display monitor 36 is also coupled to the platform 22 via a wired connection 38. As an alternative, the wired connections 34 and 38 can be replaced by wireless connection using wireless communication techniques that are well-known in the art.

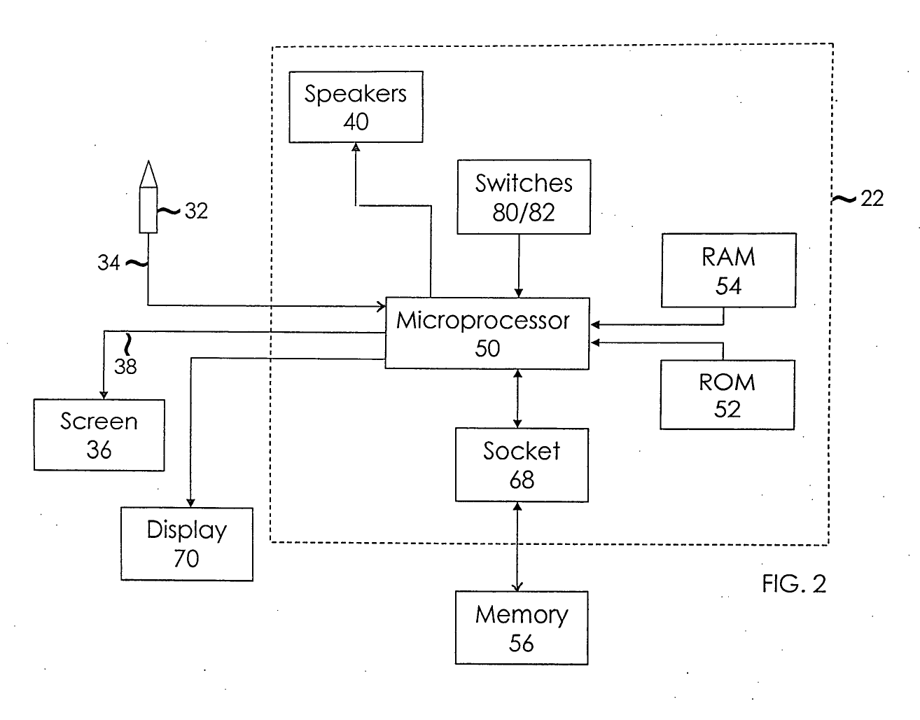

The platform 22 houses its associated electronics (see FIG. 2) and operates with the stylus 32 and the screen 36 to detect the area inside the receiving zone 24 to which the stylus 32 is pointed. As the user turns the pages of the book 26, the user uses the stylus 32 to point to particular words, pictures, symbols, images or patterns. As the user points to particular words, pictures, symbols, images or patterns, an audio output is emitted from a speaker 40 provided on the platform 22, and an image or streaming video is simultaneously played on the screen 36. In particular, the stylus 32 enables the co-ordinate location of that area to be determined by the platform 22, with the stylus 32 being (for example) magnetically or capacitatively coupled to the platform 22 through the pages of the book 26.

The stylus 32 and the platform 22 (including the electronics) may be embodied in the form of any of the conventional stylus and graphics tablets described in U.S. Pat. Nos. 5,575,659, 6,668,156 and 7,035,583, whose entire disclosures are incorporated by this reference as though set forth fully herein. The principles described in U.S. Pat. No. 5,877,458 can also be applied to determine the position of the stylus 32. For example, a conductive sheet (similar to 100 in U.S. Pat. No. 5,877,458) can be applied to the pages or surfaces of the book 26, or to the receiving zone 24 of the platform 22, a signal generator (similar to 122 in U.S. Pat. No. 5,877,458) can be coupled to the microprocessor 50, and a signal measurement stage (similar to 120 in U.S. Pat. No. 5,877,458) can be coupled between the microprocessor 50 and the stylus 32, to implement the position determination method of U.S. Pat. No. 5,877,458. In addition, the stylus 32 can be omitted and the system 20 can utilize a user's finger as a selector to detect the selected location, as described in Pub. No. US2004/0043365 and U.S. Pat. No. 5,877,458, whose entire disclosures are incorporated by this reference as though set forth fully herein.

The platform 22 is designed to accommodate any print medium. The print medium can take the form of books and single sheets. The single sheets can include paper, cards, placemats, and even gameboards. The book can have any binding or spine. In some embodiments, the platform 22 may have a detection mechanism to determine when a user turns a page of a book so that the microprocessor can be cued as to the page that the user is viewing. Examples of such page detection mechanisms are illustrated in U.S. Pat. Nos. 6,668,156 and 7,035,583, and in Pub. No. US2004/0043365, whose entire disclosures are incorporated by this reference as though set forth fully herein.

The receiving zone 24 may be sunken or recessed to define a receiving space into which a book 26 (or single sheets) can be snugly fitted, thereby ensuring that the position of the book 26 and its pages (or the single sheets) are consistently located in proper relationship to the programmed regions for the specific words, pictures, symbols, images or patterns. Consistent book positioning can also be accomplished by providing a slot to accommodate the binding of the book 26, or page notches to detect which pages or single sheets are being positioned in the receiving zone 24. Examples of such positioning mechanisms are illustrated in U.S. Pat. Nos. 6,668,156 and 7,035,583, whose entire disclosures are incorporated by this reference as though set forth fully herein. The surface of the receiving zone 24 can be provided with a conductive sheet that is similar to the sheet 100 in U.S. Pat. No. 5,877,458, or provided with a dual-antenna substrate that is similar to the substrate 670 in U.S. Pat. No. 6,661,405, or provided with grids similar to the grids 142, 170 in U.S. Pub. No. 2004/0043365, depending on the position detection system and method being utilized. The entire disclosure of U.S. Pat. No. 6,661,405 is incorporated by this reference as though set forth fully herein. Referring now to FIG. 2, the co-ordinate details of the pointed area are provided to a microprocessor 50, which operates under the control of a program stored in a memory 52 (e.g., a ROM). Another memory 54 (e.g., a RAM) stores the data addresses of the audio and video signals corresponding to the various areas of the page (i.e., sheet or book) being read. These audio and video signals can be stored in another memory 56. The microprocessor 50 outputs the data address to the memory 56, which provides the selected audio and video signals back to the microprocessor 50 to be subsequently transmitted to the speaker 40 and the screen 36 (via the wire 38).

The memory 56 can be provided inside the platform 22, or as a separate an external memory device such as a compact disk or cartridge that accompanies (or is sold with) the book 26 or sheet. If the memory 56 is provided in the form of an external memory device, then it can be coupled with the microprocessor 50 via an input/output (I/O) interface 68, which can be embodied in the form of a socket or port provided on an optional display 70 that has a screen 71. An on-off switch 80, and other control switches (e.g., 82) can be provided on the platform 22. These switches 80, 82 and other control switches can be used to control the volume or other settings associated with the system 20. A power supply (not shown) is provided in the platform and coupled to the electronics in FIG. 2, and can be embodied in the form of any conventional power supply, including batteries. The platform 22 can further include an optional display 70 that can be hingedly connected to the platform 22 so that the display 70 can be raised (as shown in FIG. 1) or pivoted into a recessed region 78 on the platform 22. The screen 71 on the display 70 can be used to display the same images as the screen 36, so that the screen 36 can be viewed by people other than the user while the user is viewing the display 70. Alternatively, the display 70 can be used to display instructions or other secondary or background images. For example, the screen 36 can be used to display images relating to a “real-life” event or experience, while written instructions can be separately and simultaneously displayed on the display 70 without detracting from the “real-life” experience provided by the screen 36 and the speaker 40.

The platform 22 can be foldable to reduce the overall size of the platform 22 for storage and transportation. The platform 22 can be divided into separate panels 72 and 74 that are connected by a hinged connection 76. A latch (not shown) or other locking mechanism can be provided on the panels 72, 74 to secure the panels 72, 74 together in a folded or closed orientation.

In use, the user turns on the system 20, and selects a desired book 26 and accompanying cartridge 56 (if applicable) to be read. The user positions the book 26 in the receiving zone 24 and inserts the cartridge 56 into the interface 68. The microprocessor 50 downloads the data from the selected cartridge 56 (or from the RAM 54 if the cartridge 56 is not used), and the system 20 detects the opened pages 28 and 30 using the page detection techniques referred to above. The user then selects words, pictures, symbols, images or patterns on the opened pages 28, 30 using the stylus 32 or his/her own fingers. The system 20 detects the selected words, pictures, symbols, images or patterns, and provides both a video output via the screen 36 and an audio output via the speaker 40. The audio and video output is based on the data stored in the selected cartridge 56 or the RAM 54.

For example, if the book 26 tells a story, then the video output can be in the form of streaming video images that simultaneously accompany the part of the story that is being read (i.e., transmitted in audio form via the speaker 40). This allows the reader to experience the story unfolding before him/her in a “live” manner, so that the system 20 provides the user with more than just an audio experience.

As another example, if the book 26 is an educational book about wildlife, then the video output can be in the form of streaming video images of the animals and wildlife that are associated with the words or animals selected by the user, to simultaneously accompany the audio part of the narrative or description that is being read (i.e., transmitted in audio form via the speaker 40). This allows the reader to have a more “real-life” experience of the subject matter that is being read to the user.

As yet another example, if the book 26 is an educational book that teaches the user how to cook a dish, or make an object, then the video output can be in the form of streaming video images of the steps of the cooking or making process that are associated with the words or images selected by the user, to simultaneously accompany the audio part of the narrative or description that is being read (i.e., transmitted in audio form via the speaker 40). This provides the user with a more accurate and “hands-on” learning experience.

In addition, if the screen 36 is a conventional television unit, then it is also possible to omit the speaker 40 from the platform 22, with the audio output being output from the speakers (not shown) in the television unit.

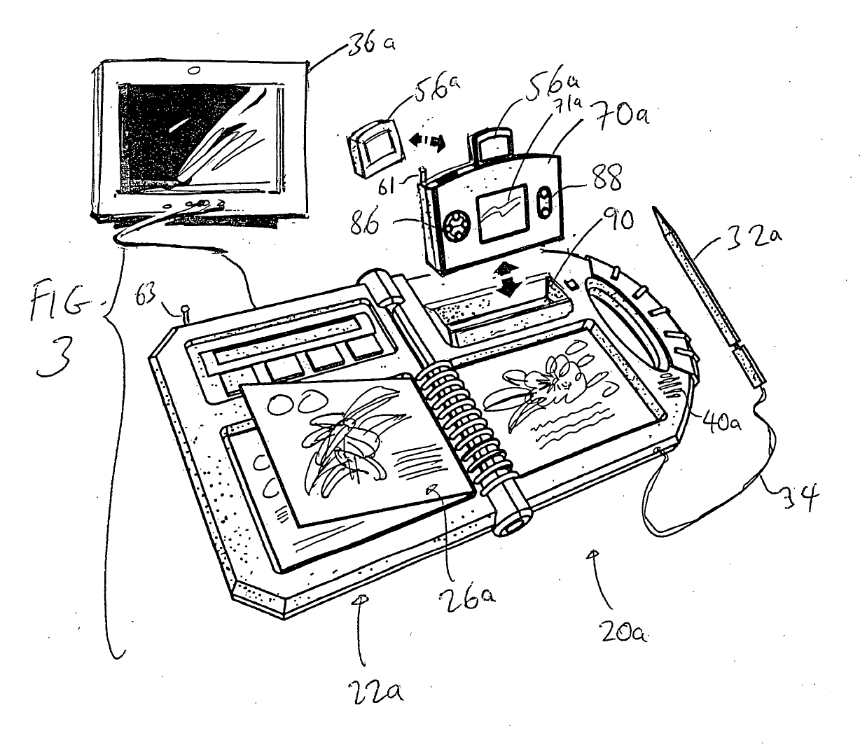

FIG. 3 illustrates a modification that can be made to the system 20 in FIG. 1. In the system 20a in FIG. 3, the display 70 can be converted into a hand-held unit 70a that can be used separately from the system 20a for other functions. For example, the hand-held unit 70a can be used as a conventional game unit that has a screen 71a and control buttons 86 and 88. The hand-held unit 70a can be received inside a receiving socket 90 that is provided on the platform 22a for receiving hand-held unit 70a. An antenna 61 can be provided on the hand-held unit 70a and coupled to the electronics (not shown) in the hand-held unit 70a. The electronics in the hand-held unit 70a can include a processor and one or more memories (including a RAM and a ROM) that are typically provided in conventional hand-held game units, and will not be described in greater detail. Another antenna 63 can be provided on the platform 22a, and coupled to the microprocessor 50. Wireless communication between the hand-held unit 70a and the microprocessor 50 in the platform 22a is accomplished via the antennas 61 and 63. Thus, in this application, the system 20a would provide a combined interactive book device and game unit, with the separate game unit adapted to offer the user games that relate to the subject matter of the book 26a.

For example, if the book 26a is about an action hero, the cartridge 56a can store games that relate to the action hero. The user can use the stylus 32a to point to selected regions on the opened pages of the book 26a, and the speaker 40a and the screen 36a will provide simultaneous audio and video output, respectively, regarding the story. The audio and video output can be provided from data stored in the RAM (e.g., 54) inside the platform 22a. In the mean time, the user can remove the hand-held unit 70a, insert a cartridge 56a, and play a video game relating to the action hero and the story being illustrated from the book 26a. Thus, the user can experience a complete “live” experience for the story by listening to (via the speaker 40a), viewing (via the screen 36a), and enacting (via the screen 71a on the hand-held unit 70a) the story.

As another example, if the book 26a is about wildlife, the cartridge 56a can store short video programs that relate to the different types of wildlife illustrated in the book. The user can use the stylus 32a to point to selected regions on the opened pages of the book 26a, and the speaker 40a and the screen 36a will provide simultaneous audio and video output, respectively, regarding the selected animals. The audio and video output can be provided from data stored in the RAM (e.g., 54) inside the platform 22a. In the mean time, the user can remove the hand-held unit 70a, insert a cartridge 56a, and use the control buttons 86 and 88 to activate different programs or games relating to the selected animals. Thus, the user can experience a complete “live” experience for the wildlife by listening to (via the speaker 40a) and viewing a variety of programs (via the screen 36a and the hand-held unit 70a) relating to the selected animals.

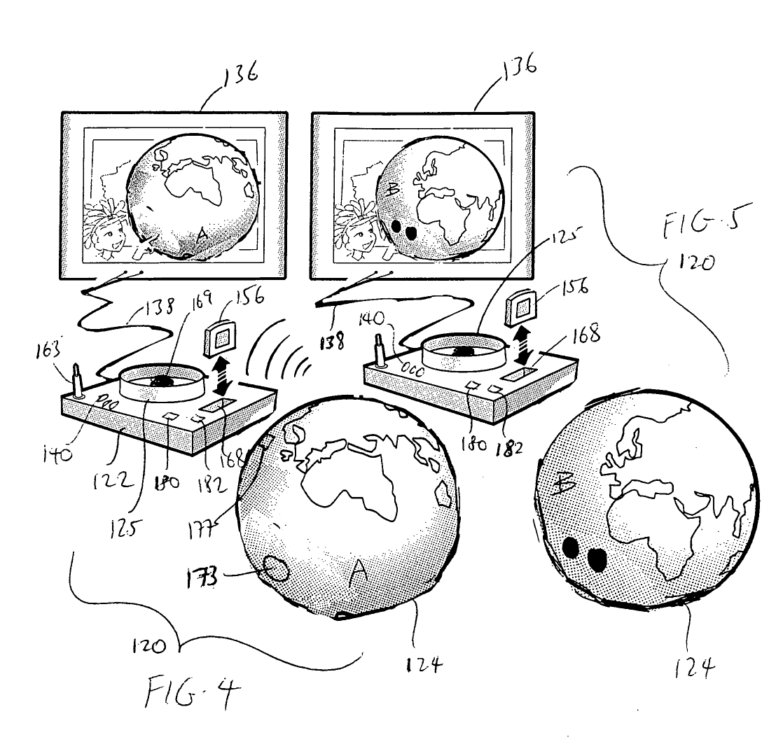

The principles of the present invention can also be extended beyond books to other three-dimensional objects that can include globes, toys and other objects. Even though the embodiments in FIGS. 4-10 are illustrated in connection with a globe or spherical object, the same principles can be applied to any three-dimensional object having a symmretrical, assymmetrical, or irregular shape. FIGS. 4-6 illustrate an interactive system 120 that includes a platform 122 that supports a globe 124, with a screen or visual display monitor 136 coupled to the platform 122 via a wired connection 138 (which can also be a wireless connection). The components of the system 120 are very similar to the components of the system 20, with the platform 122 including a speaker 140, a microprocessor 150, a ROM 152, a RAM 154, a socket 168, and switches 180/182 that can be the same as the speaker 40, microprocessor 50, ROM 52, RAM 54, socket 68 and switches 80/82, respectively, in the system 20. A cartridge 156 (which can be the same as cartridges 56/56a) is removably connected to the socket 168. A receiving well 125 can be provided on the top of the platform 122. The receiving well 125 can be embodied in the form of a circular wall that is adapted to have the globe 124 seated on the top annular edge of the circular receiving well 125. A protruding socket 169 is provided inside the receiving well 125, and extends upwardly from the top of the platform 122. The socket 169 is adapted to be fitted inside a coupling bore 173 provided on the globe 124. Electrical contacts (not shown) can be provided in the coupling 173 and on the socket 169 to complete an electrical connection that allows the electronics (not shown) inside the globe 124 to communicate with the microprocessor 150 via the socket 169. The globe 124 can also communicate with the microprocessor 150 in a wireless manner by providing antennas 163 and 177 at the platform 122 and the globe 124, respectively, to allow for this communication. The antenna 177 at the globe 124 can be a conventional embedded antenna.

The globe 124 and its accompanying electronics can be configured in the same manner as any of the globes shown and described in U.S. Pat. Nos. 6,661,405 and 5,877,458, and shall not be described in greater detail herein.

The user can use a stylus (e.g., 132d in FIG. 10), or his/her finger, or any other object (e.g., a pen), to select locations or regions on the surface of the globe 124. The system 120 detects the region or location pointed to by the user using any known conventional detection system and process. As a non-limiting example, the principles described in U.S. Pat. No. 6,661,405 can be applied to determine the selected region. For example, the surface of the globe 124 can be provided with a dual-antenna substrate that is similar to the substrate 670 in U.S. Pat. No. 6,661,405. As the user points to a particular country, city or geographic region, an audio output is emitted from the speaker 140 provided on the platform 122, and an image or streaming video is simultaneously played on the screen 136. For example, FIG. 4 illustrates the user pointing to a location in South America, which can be Brazil. The streaming video on the screen 136 will play video images of Brazil, or of selected cities or areas in Brazil, while the audio output broadcasts audio information about Brazil or the selected city or area. As a result, the user is provided with a “live” feeling that he/she is actually in Brazil. When the user points to a different location (see FIG. 5), the video image on the screen 136 will change to correspond to the region of the globe 124 that has been pointed at, and the audio data will reflect the region or country that has been pointed to. The data for the video images and the audio output can be stored in the RAM 154, the ROM 152 or the memory in the cartridge 156.

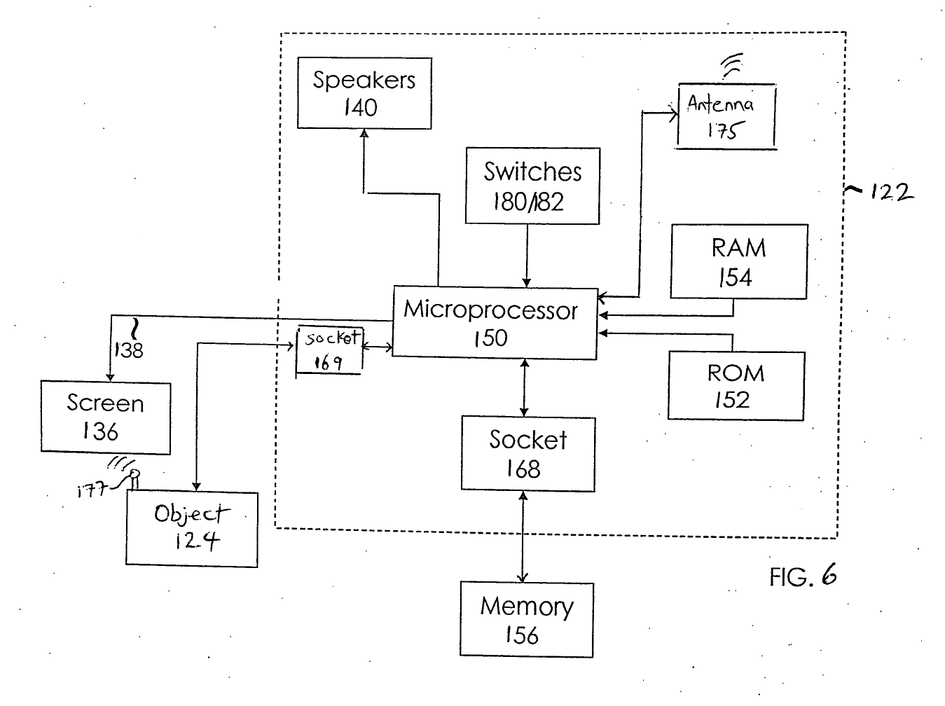

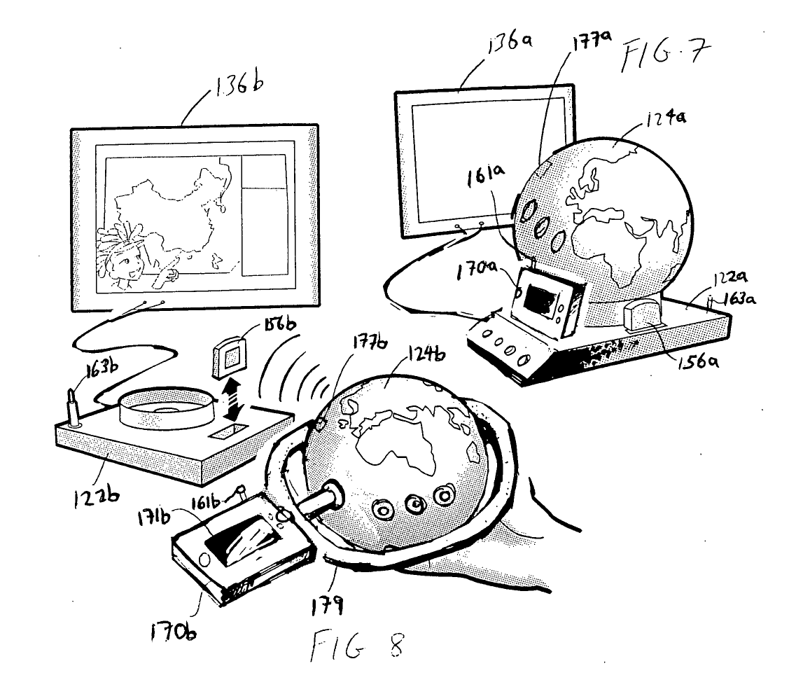

The system 120 can be modified in the same manner illustrated in FIG. 3 by providing a hand-held unit 170a, as shown in FIG. 7. The system 120a in FIG. 7 can be the same as the system 120 in FIGS. 4 and 6, except that a hand-held unit 170a (which can be the same as the hand-held unit 70a) is now incorporated in the same manner as described above for FIG. 3. The platform 122a, the globe 124a, the screen 136a and the cartridge 156a can be the same as the platform 122, globe 124, screen 136 and cartridge 156, respectively. The electronics in the hand-held unit 170a can communicate with the electronics in the globe 124 via the antennas 161a and 177a on the hand-held unit 170a and the globe 124a, respectively. The electronics in the hand-held unit 170a can also communicate with the electronics in the platform 122a via the antennas 161a and 163a on the hand-held unit 170a and the platform 122a, respectively. The principles and operation for the system 120a are the same as for the system 20a in FIG. 3, and will not be described in greater detail.

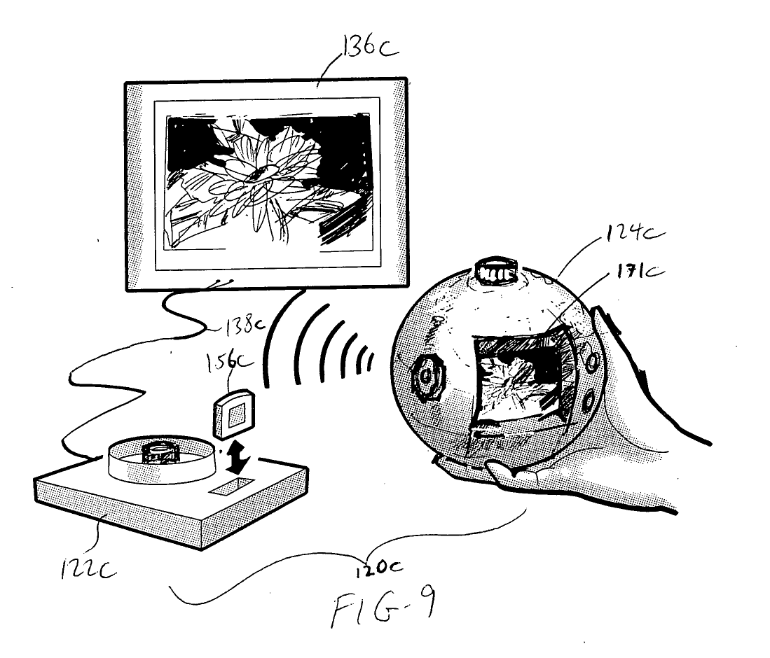

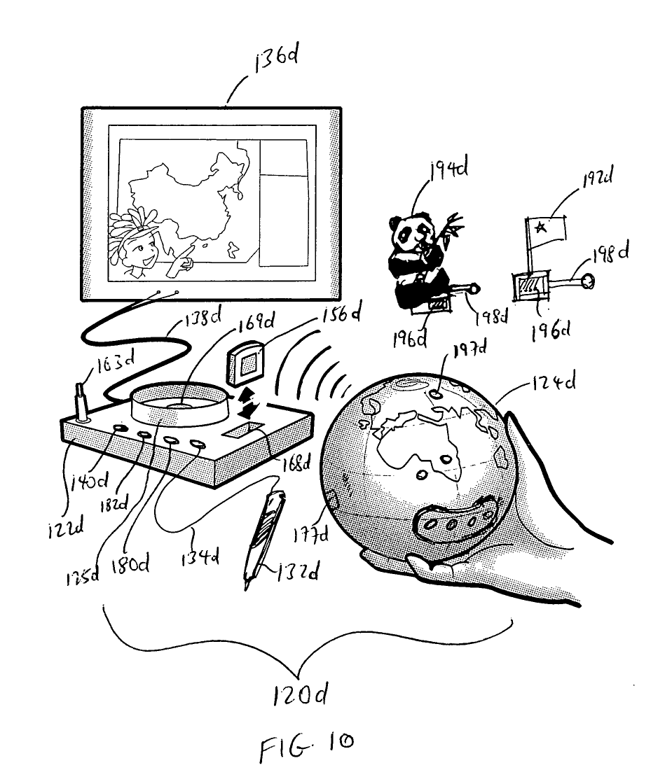

FIG. 8 illustrates a modification that can be made to the system 120a in FIG. 7. In the system 120b in FIG. 8, the hand-held unit 170b is mechanically (and possibly electrically) coupled to the globe 124b via a framework 179 so that the user can view the screen 171b on the hand-held unit 170b while holding the globe 124b. The electronics in the hand-held unit 170b can be coupled to the electronics in the globe 124b, either directly via a wired connection inside the framework 179, or a wireless connection via the antennas 161b and 177b. In addition, the hand-held unit 170b can communicate with the microprocessor 150 in the platform 122b in one of two ways: (i) via the electronics in the globe 124b and the antennas 163b and 177b, or (ii) directly via the antennas 161b and 163b. The platform 122b, the globe 124b, the screen 136b and the cartridge 156b can be the same as the platform 122, globe 124, screen 136 and cartridge 156, respectively, in FIG. 4. The principles and operation for the system 120b are the same as for the system 120a in FIG. 7, and will not be described in greater detail. FIG. 9 illustrates a modification that can be made to any of the systems 120, 120a or 120b. The system 120c in FIG. 9 shares the same components as the system 120 in FIG. 4, except that a screen 171c is provided in the globe 124c.

Another way to view the system 120c is that the hand-held units 170a and 170b in the systems 120a and 120b have been omitted, with the screen 171a or 171b being moved to the globe 124c. The screen 171c can be coupled to the electronics (not shown) in the globe 124c, and be used to display images and video data in the same manner disclosed above for the screens 171a or 171b.

FIG. 10 illustrates additional features that can be provided to the system 120 of FIG. 4. Other than the additions described below, the system 120d in FIG. 10 is the same as the system 120 in FIG. 4, so the same numeral designations will be used in both FIGS. 4 and 10 except that a “d” will be added to the designations for the same elements in FIG. 10.

The system 120d includes the use of a stylus 132d that is coupled via a wire 134d to the platform 122d. The stylus 132d and the wire 134d can be the same as the stylus 32 and the wire 34, respectively, in FIG. 1, and can be coupled to the microprocessor 150 in the same manner as illustrated in FIG. 2. The provision of the stylus 132d is for illustrative purposes only, as the system 120d can be operated without a stylus (like the systems 120, 120a, 120b, 120c), or the stylus 132d can be incorporated into any of the other systems 120, 120a, 120b, 120c.

The system 120d further includes a plurality of accessories that can be embodied in the form of any object that is associated or related to the subject matter of the globe 124d. For example, for a globe application, the object can be a flag 192d of a country, or an animal 194d (e.g., panda) that symbolizes a country. Each object 192d, 194d includes a chip 196d on which may be provided an antenna that is used for communicating (wirelessly) with either the antenna 177d on the globe 124d or the antenna 163d of the platform 122d. Each chip 196d can also include a processor (not shown) and memory (not shown) that stores data relating to its application for features. For example, the memory in the chip 196d for the flag 192d can contain pre-stored data relating to the specific country, while the memory in the chip 196d for the panda 194d can contain pre-stored data relating to pandas. In terms of powering the chip 196d, the chip 196d can be a conventional passive chip or a conventional active chip. Each object 192d, 194d further includes a support peg 198d that is adapted to be inserted into a corresponding socket 197d in the surface of the globe 124d. The support peg 198d supports the object 192d, 194d in the socket 197d during use or play. As an alternative, magnets, VELCRO™, or other connections can be used to removably couple the object 192d, 194d to the surface of the globe 124d.

In use, the user can insert a flag 192d into the corresponding socket 197d for the country (instead of using the stylus 132d or a finger to select the country) to trigger corresponding audio and video output associated with the country. The microprocessor 150 in the platform 122d will identify the flag 192d based on an interchange of data via the antenna 163d and the antenna in the chip 196d of the flag 192d. The audio and video data can be stored in the memory in the flag 192d, or in any of the memories in the platform 122d or the globe 124d. Similarly, the user can insert the panda 194d into the corresponding socket 197d for China (instead of using the stylus 132d or a finger to select China) to trigger corresponding audio and video output associated with the panda. The microprocessor 150 in the platform 122d will identify the panda 194d based on an interchange of data via the antenna 163d and the antenna in the chip 196d of the panda 194d. The audio and video data can be stored in the memory in the panda 194d, or in any of the memories in the platform 122d or the globe 124d.

There are a variety of ways in which the objects 192d, 194d can be deployed, and communicate, with the platform 122d and the globe 124d. According to one embodiment, each peg 198d can be configured in a different shape, and each socket 197d can be configured in a corresponding shape, so that only the intended object can be inserted into the correct socket 197d. According to this embodiment, electrical contacts (not shown) can be provided in the sockets 197d to detect the presence of a peg 198d.

According to another embodiment, the user must select and activate (via the switches 180d, 182d, which can be control buttons) operation involving the use of the objects 192d, 194d. Once activated, the microprocessor 150 will direct the antenna 163d to detect and convey signals from the antennas in the objects 192d, 194d. In this embodiment, the microprocessor 150 may pick up signals from more than one object 192d, 194d, upon which the microprocessor 150 will cue the user to select the object 192d, 194d whose audio and video data is to be output. Alternatively, the microprocessor 150 can broadcast the audio and video output for each detected object 192d, 194d on a sequential or random or repeating basis.

According to yet another embodiment, the microprocessor in the globe 124d will direct the antenna 177d to detect and convey signals from the antennas in any objects 192d, 194d that are in the vicinity of the antenna 177d. All signals detected by the antenna 177d will be relayed to the microprocessor 150 via the antenna 163d, upon which the microprocessor 150 can either cue the user to select the object 192d, 194d whose audio and video data is to be output, or the microprocessor 150 can broadcast the audio and video output for each detected object 192d, 194d on a sequential or random or repeating basis.

Even though the embodiments in FIGS. 4-10 are illustrated in connection with a globe or spherical object, the same principles can be applied to any three-dimensional object having a symmetrical, assymmetrical, or irregular shape. For example, the globe 124 can be replaced by an irregular-shaped object, which can be a toy (such as a teddy bear), a miniature vehicle, or an educational object (such as a model skeleton). The external surfaces of the teddy bear, vehicle or model skeleton can be configured so that a user can generate an audio and a video response by touching or selecting a location. For example, when the user selects or touches the wheels of the vehicle, the audio output can resemble rumbling wheels, or include a narrative of the functions and characteristics of the wheels, while the video images can show how the wheels function or operate. Similarly, when the user selects or touches the spine of a model skeleton, the audio output can include a narrative of the functions and characteristics of the spine, while the video images can show how the spine functions or operates. As yet another example, when the user selects or touches the limbs of the teddy bear, the audio output can include anything from a narrative of the functions and characteristics of the limbs of a bear, to playful music relating to the teddy bear, while the video images can show a cartoon about the teddy bear, or allow the user to simulate a game relating to the teddy bear.

Although the present invention illustrates platforms 22, 122, 122a, 122b, 122c having particular constructions and configurations, these platforms can be embodied in the form of any housing assembly that houses the electronics and supports the object (book, globe, etc.) that is the subject of the system.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. An interactive electronic system, comprising:
a housing;
a three-dimensional object having an external surface;
a selector that selects a specific location on the external surface;
electronics housed in the housing;
a video screen electrically coupled to the electronics, the video screen displaying video images associated with the specific location; and
wherein the electronics respond to the specific location selected by the selector and transmits to the video screen signals representative of the video images.

2. The system of claim 1, wherein the object is a globe.

3. The system of claim 1, wherein the housing has means for receiving the object.

4. The system of claim 3, wherein the housing comprises a platform, and the receiving means comprises a well having an annular wall.

5. The system of claim 3, further including a speaker provided in the housing.

6. The system of claim 3, further including a memory that is removably coupled to the housing.

7. The system of claim 1, wherein the electronics includes:
a processor;
a first memory that stores a program that controls the operation of the processor; and
a second memory that stores the data addresses of the video image signals corresponding to the specific locations.

8. The system of claim 3, wherein the video screen is separate and spaced-apart from the housing.

9. The system of claim 1, further including:
a hand-held unit that has at least one control button and a screen.

10. The system of claim 9, further including:
a cartridge having a memory that stores programs, with the screen on the hand-held unit displaying images from the programs.

11. The system of claim 8, further including a screen on the object, the screen on the object displaying images associated with the specific location.

12. A method of illustrating the subject matter provided on an external surface of a three-dimensional object, comprising:
a. providing an interactive system comprising:
a three-dimensional object;
a housing;
a selector; and
a video screen;
b. using the selector to select a specific location on the external surface of the object; and
c. displaying at the video screen video images associated with the specific location.

13. The method of claim 12, wherein step (c) further includes:
simultaneously broadcasting audio output associated with the specific location.

14. The method of claim 12, further including:
providing a hand-held unit that has a control button and a screen; and
causing the screen on the hand-held unit to display images relating to the selected location.

15. An interactive electronic system, comprising:
a three-dimensional object having an external surface;
a housing;
a selector that selects a specific location on the external surface;
electronics housed in the housing;
a video screen electrically coupled to the electronics, the video screen displaying video images associated with the specific location;
wherein the electronics respond to the specific location selected by the selector and transmits to the video screen signals representative of the video images; and
wherein the selector includes a chip having means for communicating with the electronics.

16. The system of claim 15, wherein the selector is an object that is representative of the selected location.

17. The system of claim 15, wherein a socket is provided on the external surface of the object, and the selector is received inside the socket.
